(19) United States
(12) Patent Application Publication
(10) Pub. No.: US 2008/0125119 A1
(43) Pub. Date: May 29, 2008

(54) MOBILE REGISTRATION SYSTEM

(75) Inventors: Cindy Corritore, Waterloo, NE (US); Nate Rempe, Lincoln, NE (US)

Correspondence Address: POLSINELLI SHALTON FLANIGAN SUELTHAUS PC, 700 W. 47TH STREET, SUITE 1000, KANSAS CITY, MO, 64112-1802, US

(73) Assignee: CREIGHTON UNIVERSITY, Omaha, NE (US)

(21) Appl. No.: 11/941,679

(22) Filed: Nov. 16, 2007

Related U.S. Application Data
(60) Provisional application No. 60/866,188, filed on Nov. 16, 2006.

(51) Int. Cl. H04Q 7/20; H04M 1/66

(52) U.S. Cl. 455/435.1; 455/411

(57) ABSTRACT

A method and system for registering for a course of an educational institution with a telecommunication device via a mobile registration system being executed on a server is disclosed. The server sends registration notifications to the telecommunication devices of a student eligible to participate the mobile registration system. A student operates their telecommunication device to send a registration request to the server to receive registration data. The mobile registration system then retrieves the requested registration data, and based on an infinite number of business rules, performs a smart interpretation convenient when accessing the information via a mobile telecommunications device.

### RELATED APPLICATIONS

This application claims the benefit of the filing date of U.S. Provisional Application No. 60/866,188, entitled Mobile Registration System, filed Nov. 16, 2006, the entire contents of which are incorporated herein by reference.

### FIELD

The present document relates to a mobile registration system, and more particularly to a mobile registration system that permits a user to register for academic courses over a mobile telecommunication device or the like.

### BACKGROUND

With the growth of computer and information systems and related network technologies, such as wireless and Internet communications, ever increasing amounts of electronic information are communicated, transferred and subsequently processed by users and/or systems. As an example, wireless telecommunication devices, such as mobile phones, are not only a popular method for voice communications, but are also a popular means for communicating various types of electronic information. In particular, with the advent of wireless Internet technology, telecommunication devices are being used more frequently to retrieve and view information available via a communication network, such as, for example, the Internet. As a result, telecommunication devices conveniently provide users the ability to access the Internet for the purposes of interacting with various types of web services.

Educational institutions such as colleges and universities frequently offer web based registration services to provide students and/or faculty access to information regarding available courses via the Internet during a registration period. Moreover, such web based registration services allow students to register for desired courses via the Internet during the registration period. However, such conventional registration services require that the student have access to a client computer, such as a personal computer or laptop, to effectively view and interact with the information available via the registration service.

### SUMMARY

According to one embodiment, a method is provided for registering for a service via a telecommunication device. The method includes storing registration data in a registration database at a server with the registration data including user registration data and service registration data. The method also includes identifying an eligible user from the user registration data and transmitting a registration notification from a server to the telecommunication device of the eligible user. The registration notification notifies the eligible user that registration for the service is available. The method further includes a registration request at the server from the eligible user via the telecommunication device. The registration request requesting service registration data from the server and converting the service registration data from a first format to a second format. The first format configured for viewing on a non-telecommunication device and the second format configured for viewing on the telecommunication device. The method also includes displaying the service registration data in the second format on a display of the telecommunication device and receiving input data at the server from the user via the telecommunication device. The input data defines a registration preference for the service. The method further includes registering the user for the service based on the input data.

According to another embodiment, one or more computer-readable media having computer-executable components is provided for allowing a user to interact with registration data for a service via a telecommunication device. The computer-readable media includes a registration database to store registration data with the registration data comprising user registration data and service registration data. The computer-readable media further includes a notification component responsive to the user registration data to transmit a registration notification to the telecommunication device of at least one user. The registration notification notifies the at least one user that registration for the service is available. The computer-readable media further includes an authentication component to authenticate a registration request received from the user via the telecommunication device by authenticating that the user has registration authority for the service. A retrieval component is responsive to an authenticated registration request to accept an action request received from the telecommunication device and to retrieve specific registration data identified by the action request. The computer-readable media further includes a conversion component to convert the specific registration data from a first format to a second format that can be viewed on the telecommunication device. A transfer component is provided to transfer the converted registration data in the second format to the telecommunication device for display to the user.

According to another embodiment, a computerized system is provided for registering a user for a service in response to a registration request received at a server computer from a telecommunication device with the registration request including information identifying the user. The system further includes a registration database to store registration data that includes user registration data and service registration data. The system includes a server application comprising an authentication component to authenticate the registration request received from the user via the telecommunication device by authenticating that the user has registration authority for the service. A retrieval component is responsive to an authenticated registration request to accept an action request received from the telecommunication device and to retrieve specific registration data identified by the action request. A conversion component is provided to convert the specific registration data from a first format to a second format that can be viewed on the telecommunication device. The system further includes a transfer component to transfer the converted registration data in the second format to the telecommunication device for display to the user.

According to another embodiment, a computerized system is provided for displaying data from a server application on a telecommunication device. The computerized system includes a task optimization engine module template table comprising a list of templates. The list of templates identifies a supported server application. The system further includes an interpreter template table comprising another list of templates, wherein each of the other list of templates specifies business rules for converting data included in one or more web pages of the desired server application from a first format to a second format that can be viewed on the telecommunication device. The system further includes a task optimization engine module for receiving an action request from a telecommunication device with the action request specifying a desired server application and specifying data to retrieve from the desired server application. The task optimization engine module is responsive to the action request to retrieve the list of templates from the task optimization engine module template table. The task optimization engine module is also further responsive to the action request to compare the desired server application to each the supported server applications identified by the list of templates to identify a match between the desired server application and a supported server application. The task optimization engine module is further responsive to the action request to transmit a hyper text transfer protocol (http) request to the desired server application only if the desired server application matches a supported server application. The system further includes an interpreter module to intercept a http response from the desired application with the http response including the data specified by the action request. The interpreter module is responsive to the http response to retrieve the other list of templates from the interpreter template table. The interpreter module is further responsive to compare the http response data included in the http response to each of the other list of templates to identify a corresponding interpreter template and to compare the http response to convert the data included in the http response from the first format to the second format based on the business rules included in the corresponding interpreter template. The interpreter module also compares the http response to generate a wireless application protocol (WAP) response comprising data in the second format. The system further comprises a transfer component to transmit the WAP response to the telecommunication device, wherein the telecommunication device is responsive to the WAP response to display the data in the second format.

Additional objectives, advantages and novel features will be set forth in the description which follows or will become apparent to those skilled in the art upon examination of the drawings and detailed description which follows.

### BRIEF DESCRIPTION OF THE DRAWINGS

FIG. 1 is a block diagram illustrating a suitable operating environment in which embodiments of the mobile registration system may be implemented;

FIG. 2A is a block diagram illustrating components of a server application according to one embodiment of the mobile registration system;

FIG. 2B is a screen shot of a directory form for defining registration data according to one embodiment of the mobile registration system;

FIG. 2C is a block diagram illustrating modules of a conversion component according to one embodiment of the mobile;

FIG. 3A is a block diagram illustrating components of a client application according to one embodiment of the mobile registration system;

FIG. 3B is a front view of a telecommunication device for interacting with a server according to one embodiment of the mobile registration system;

FIG. 4A-4J show various graphical user interfaces displayed on the telecommunication device according to one embodiment of the mobile registration system;

FIG. 5 is a flow chart illustrating a method for accessing the mobile registration system;

FIG. 6 is a flow chart illustrating a method for transferring registration data from a server to a telecommunication device of the mobile registration system; and

FIG. 7 is a flow chart illustrating a method for transferring registration data from a server to a telecommunication device according to another embodiment of the mobile registration system.

Corresponding reference characters indicate corresponding elements among the several views. The headings used in the figures should not be interpreted to limit the scope of the figures.

### DETAILED DESCRIPTION

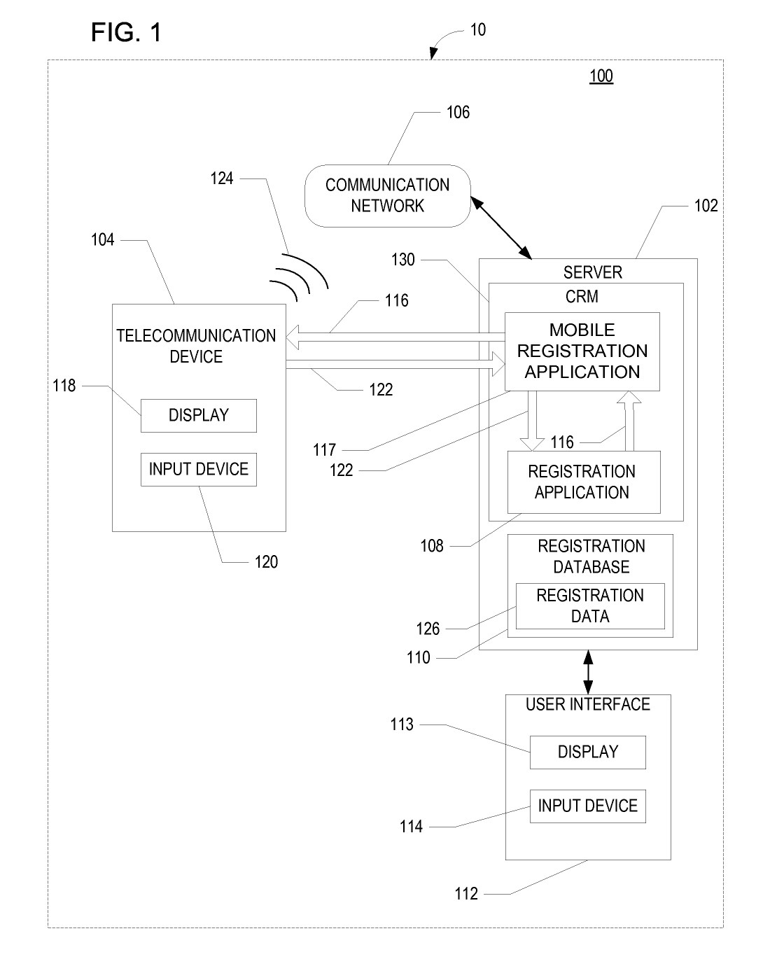

Referring to the drawings, a system and method for implementing a mobile registration system is generally indicated as 10 in FIG. 1. As shown, FIG. 1 shows a block diagram illustrating the various components of the mobile registration system 10 that operates in an operating environment 100 in which aspects of the mobile registration system 10 may be implemented. In this instance, FIG. 1 diagrammatically shows cross network communication between a central server 102 and a telecommunication device 104 in operating system 100. More specifically, embodiments of the mobile registration system 10 are described in the context of the central server 102 being communicatively linked to the telecommunication device 104 such that data can be exchanged between the central server 102 and the telecommunication device 104. The central server 102 may be operatively associated to the telecommunication device 104 via a data communication network 106. In this example, the data communication network 106 may be the Internet (or the World Wide Web) that facilitates the transfer of registration data between the central server 102 and the telecommunication device 104. However, the teachings of the mobile registration system 10 can be applied to any data communication network. In this example, the central server 102 and telecommunication device 104 may communicate data among themselves using a Wireless Application Protocol (WAP) which is a protocol commonly used to provide Internet service to digital mobile phones and other wireless terminals.

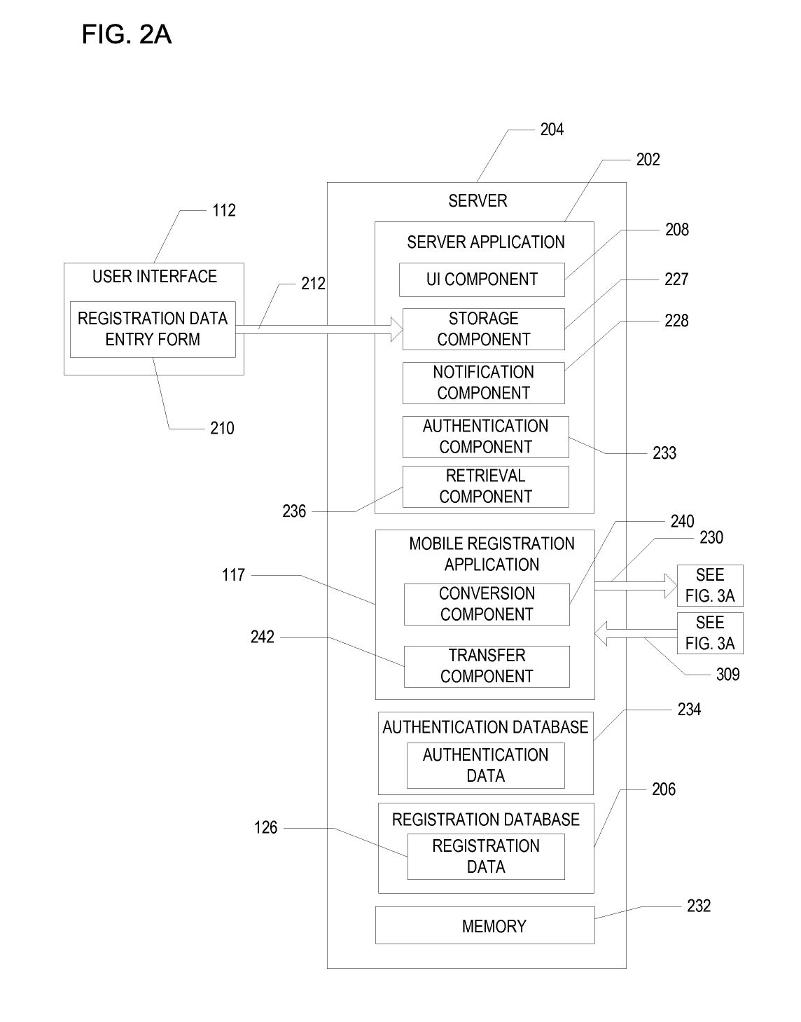

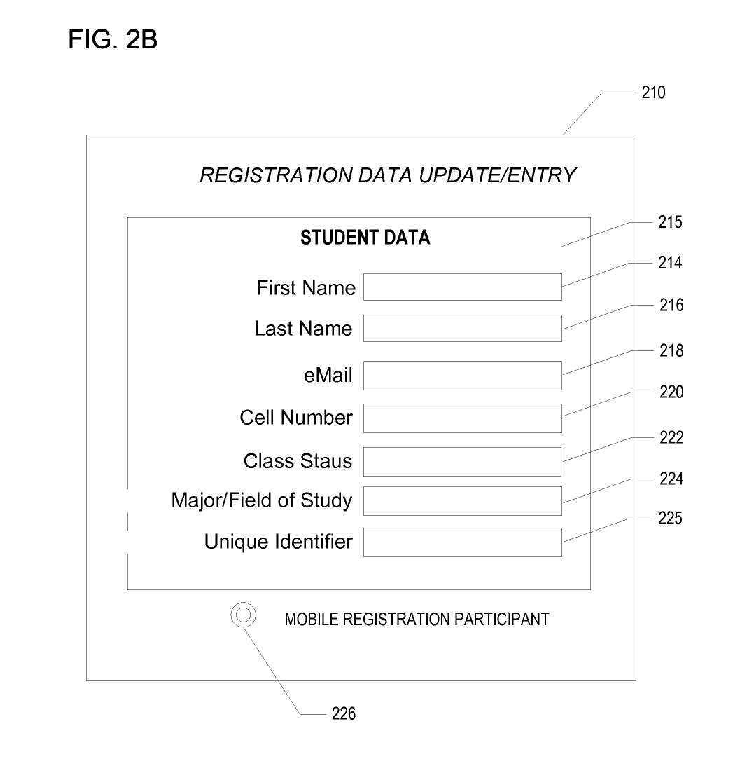

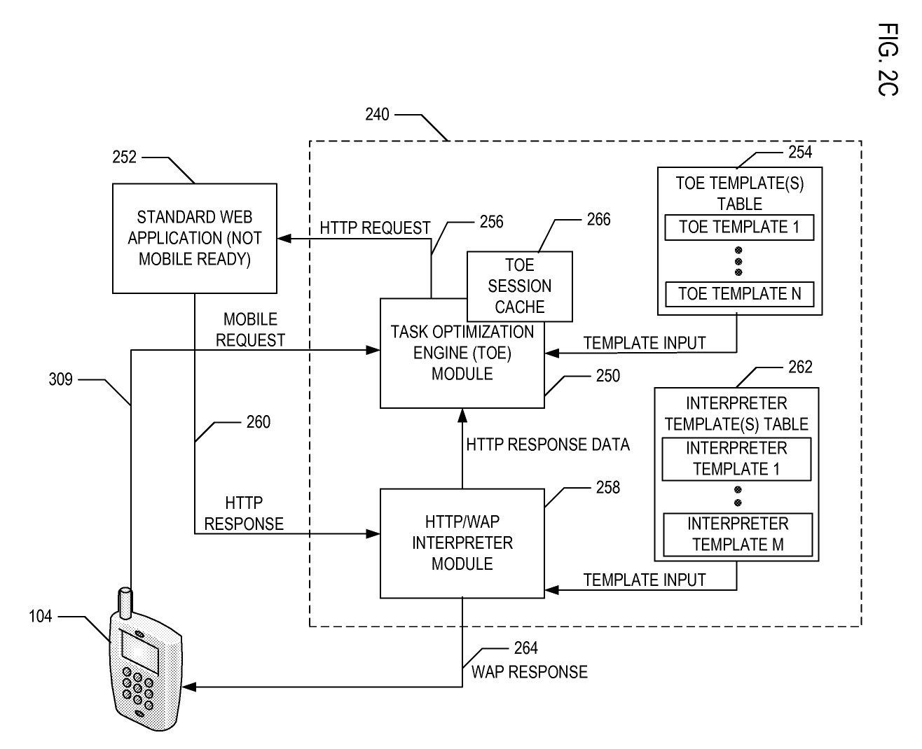

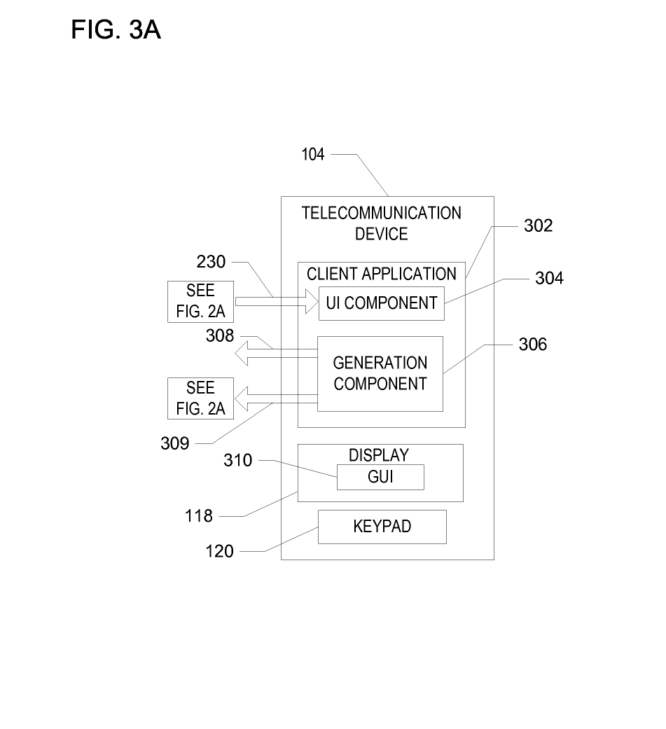

A user-interface (UI) 112 may be operatively coupled to the central server 102 such that an administrator, or user, of the central server 102 may interact with a registration application 108 to define and/or update registration data 126 stored in a registration database 110. The registration database 110 stores registration data 126, which may include user registration data such as the first name, last name, email address, phone number, mailing address, class schedule, class status (e.g., freshman, sophomore, etc), and area of study for one or more students. The registration data may also include service registration data such as times and days of the week for classes and instructors assigned to a particular class. Other types of registration data 126 are also contemplated. The UI 112 may include a display 113, such as a computer monitor, for viewing registration data 126 and/or input forms, and an input device 114, such as a keyboard or a pointing device (e.g., a mouse, trackball, pen, or touch pad), for entering registration data 126 for a particular student into the input form (FIG. 2B). For example, the administrator can use an input form to enter or to update a phone number associated with telecommunication device 104 for a particular student.

The central server 102 executes the registration application 108 in order to transmit registration notifications to one or more telecommunication devices 104 of particular students eligible to participate in mobile registration for courses under the mobile registration system 10. A registration notification, as indicated by arrow 116, can be a predefined text or any other electronic communication message that informs the student that mobile registration for courses is now available for that student under the mobile registration system 10. The registration notification 116 may include textual data and/or contextual data. Textual data includes words, numerals, punctuations etc., while contextual data may include hyperlinks, images, uniform resource locators (URLs), etc. The text message may include a hyperlink that corresponds to a location of the mobile registration system 10 (e.g., registration application 108) of the particular educational institution on the Internet or other similar network.

A mobile registration application 117 serves as an interface between the registration application 108 and telecommunication device 104 to receive the registration notification 116 and, if necessary, converts any textual and contextual data included in the registration notification 116 to a format adapted for viewing on the telecommunication device 104. The mobile registration application 117 then forwards the registration notification 116 with the converted textual and contextual data to the telecommunication device 104. As used herein, format includes both communication protocol and intelligent data reduction. In other words, converting the format of data being transferred to the telecommunication device 104 includes reducing the amount of data and anticipating a desired amount of data.

After receiving the registration notification 116, the student views the textual and contextual data on a display 118 of the telecommunication device 104. Using navigation techniques known to those skilled in the art, the user can use a keypad put device 120, such as a keypad, of the telecommunication device 104 to select contextual data, such as the hyperlink being displayed on the display 118 of the telecommunication device 104 in order to generate a registration request, as indicated by arrow 122, that is provided to the central server 102 via a wireless communication signal, as indicated by reference character 124.

The mobile registration application 117 receives the registration request 122 and forwards the request to the registration application 108. The registration application 108 is responsive to the received registration request 122 such that registration data 126 may be retrieved from the registration database 110 and transferred to the telecommunication device 104. As discussed in greater detail below in reference to FIG. 2A, the registration application 108 authenticates the received registration request 122 to determine if it is valid prior to transferring registration data 126 to the telecommunication device 104. After the telecommunication device 104 is authenticated, the registration application 108 transfers the retrieved registration data 126 to the mobile registration application 117. Prior to transferring registration data 126 to the telecommunication device 104, the mobile registration application 117 converts the retrieved registration data 126 to a format adapted for full viewing on the display 118 of the telecommunication device 104. More specifically, because the display 118 of the telecommunication device 104 is generally substantially smaller than a display associated with a conventional personal computer or a laptop computer, the mobile registration application 117 only transfers registration data 126 or performs tasks necessary to complete the desired transaction. Thereafter, the user of the telecommunication device 104 uses the input device 126 to interact with the transferred registration data 126 being shown on the display 118 of the telecommunication device 104 to view, for example, a particular course, select a particular course for registration, and/or view a course schedule. Notably, the registration application 108 is not aware of the conversion or data reduction by the mobile registration application 117. In other words, the communication appears as a standard communication session between a student and the registration application 108.

As a result, aspects of the mobile registration system 10 provide an improved mobile registration service that allows students to register for courses with an educational institution via telecommunication device 104. Although the mobile registration system 10 is described herein in the context of registration via a mobile phone, it is contemplated that the principles of the mobile registration system 10 can be applied to other telecommunication devices 104, such as personal digital assistants (PDAs), smart phones and other types of interactive wireless communication devices. In addition, although the mobile registration application 107 is illustrated in FIG. 1 as being located on the same central server 102 that executes the registration application 108, it is contemplated that the mobile registration application 117 can be executed on a different server that is connected to central server 102 via communication network 106. In other words, the mobile registration application can be considered middleware that translates information between the telecommunication device and registration application. Moreover, the principles of the mobile registration system 10 need not be limited to a registration process for courses being offered by an educational institution, but can be used in connection with a registration process for any service or activity being offered on the Internet or similar communication network.

The operating environment 100 illustrated in FIG. 1 may include a general purpose computing device (e.g., central server 102), such as a computer executing computer-executable instructions. The computing device typically has at least some form of computer readable media (e.g., CRM 130). CRM 130, which includes both volatile and nonvolatile media, removable and non-removable media, may be any available medium that may be accessed by the general purpose computing device. By way of example and not limitation, CRM 130 may include computer storage media and communication media. Computer storage media 130 may further include volatile and nonvolatile, removable and non-removable media implemented in any method or technology for storage of information such as computer readable instructions, data structures, program modules or other data. Communication media may typically embody computer readable instructions, data structures, program modules, or other data in a modulated data signal, such as a carrier wave or other transport mechanism and include any information delivery media. Those skilled in the art will be familiar with the modulated data signal, which may have one or more of characteristics set or changed in such a manner that permits information to be encoded in the signal. Wired media, such as a wired network or direct-wired connection, and wireless media, such as acoustic, radio frequency, infrared, and other wireless media contemplated by the mobile registration system 10, are examples of communication media discussed above. Combinations of any of the above media are also included within the scope of computer readable media discussed above. The computing device may include or be capable of accessing computer storage media in the form of removable and/or non-removable, volatile and/or nonvolatile memory. A user may enter commands and information into the computing device through the input device 114. Other input devices 114 (not shown) may also be connected to the computing device. The computing device may also operate in a networked environment using logical connections to one or more remote computers.

Although described in connection with operating environment 100, other embodiments of the mobile registration system 10 are operational with numerous other general purpose or special purpose computing system environments or configurations. The operating environment 100 is not intended to suggest any limitation as to the scope of use or functionality of the various embodiments of the mobile registration system 10. Moreover, the operating environment 100 should not be interpreted as having any dependency or requirement relating to any one or combination of components illustrated in the operating environment 100. Examples of well known operating systems, environments, and/or configurations that may be suitable for use in embodiments of the mobile registration system 10 include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Referring to FIG. 2A, a server application 202 (e.g., registration application 108) may be executed on a server 204 (e.g., central server 102) for facilitating mobile registration of courses being offered by an educational institution. The server application 202 manages registration data (e.g., registration data 126) stored on a registration database 206 linked to the server 204, while the registration database 206 contains registration data for various students and courses. As described above, student registration data 126 can include the first name, last name, email address, mobile phone number, mailing address, class status, and area of study. Course registration data can include course schedule, course instructor, course numbers, and credit hours.

A UI component 208 is responsive to a data entry request received from, for example, an administrator of the server 202 using a user interface device 112 to transfer a registration data entry form 210 to the UI device 112 that allows the administrator to define registration data 126 of a particular student and for a particular course for storage in the registration database 206. The UI device 112 allows the administrator to interact with the registration data form 210 to define registration data 126 to store in the registration database 206 or to update registration data 126 stored in the registration database 206. After the administrator defines registration data 126 to store in the registration database 206 or to update registration data 126 stored in the registration database 206, the UI component 208 then generates a storage request, as indicated by reference character 212.

Referring to FIG. 2B, registration data form 210 may be used by the administrator to enter registration data 126 of one or more students. In another aspect of the invention, the registration data form 210 can be used by users to enter their own registration data 126. The registration data form 210 may include various data entry fields that each correspond to a different type of student registration data 215 (e.g., registration data 126). In this example, the various data entry fields may include a first name field 214, last name field 216, email address field 218, mobile number field 220, class status field 222, and an area of study field 224, and a unique identifier field (e.g., PIN) 225. The registration data form 210 also allows the administrator to define whether a particular student desires to participate in the mobile registration process. For example, the administrator may select a mobile registration option 226 to indicate that the student desires to participate in mobile registration. As shown in FIG. 2A, a storage component 227 is responsive to the received storage request 212 in order to store the defined or updated registration data in the registration database 206.

A notification component 228 generates a registration notification 230 that is sent to telecommunication devices 104 of students via the mobile registration application 117 that are eligible to participate in mobile registration under the mobile registration system 10. As described above, the registration notification 230 can be in the form of a text or email message that informs the student that mobile registration for classes is now available. According to one aspect of the mobile registration system 10, the server application 202 sends registration notifications 230 to participating students who have been identified by the server application 204 as being eligible to participate in mobile registration via the mobile registration system 10 according to any number of pre-defined student data 215 or pieces of information. For example, the educational institution may allow engineering students to register for fall courses beginning at 8:00 AM on August 21^{st} of a particular year. This designated time and date information may be stored in memory 232 associated with the server 204, and combined with the student data 215 that is used by the server application 202 to automatically initiate transmission of registration notifications 230 to the telecommunication devices 104 of identified participating students. Alternatively, an administrator may use a user-interface (e.g., UI 112) to interact directly with the server application 202 and manually initiate the transmission of registration notifications 230.

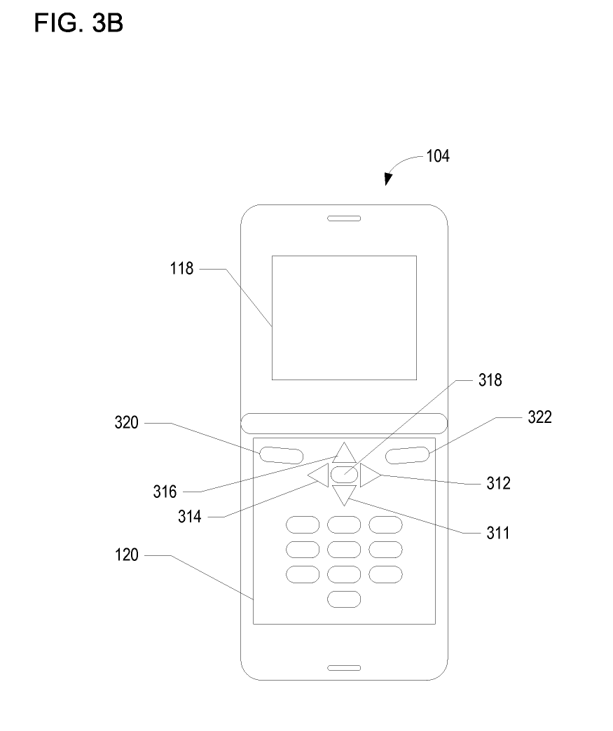

Referring to FIG. 3A, a client application 302 may be executed on the telecommunication device 104 for communicating with server 204 in order to retrieve and send registration data 126 to the server application 202. The client application 302 communicates with the server application 202 via a wireless communication network to receive data from the server 204. A UI component 304 of the client application 302 is responsive to a registration notification 230 received from the server 204 to display textual and contextual data included in the registration notification 230 on the display 118 of the telecommunication device 104.

A generation component 306 is responsive to input received from a user of the telecommunication device 104 to generate a registration request 308 (e.g., registration request 122) to retrieve registration data 126 from a registration database 206. For example, the user of telecommunication device 104 operates the user interface 120 to interact with a graphical user interface 310 shown on a display 118 of the telecommunication device 104 to select the hyperlink included in a registration notification to confirm that the student desires to participate in mobile registration service. Moreover, as discussed in greater detail below, after the user is authenticated, the generation component 306 is responsive to input received from a user of the telecommunication device 104 to generate an action request 309 to retrieve specific registration data 126 from the registration database 206.

As illustrated in FIG. 3B, telecommunication device 104 executes the client application 302 to retrieve registration data from a registration database 206 operatively linked to server 204. The client application 302 displays various graphical user interfaces on the display 118 of the telecommunication device 104 in response to user input. For example, the client application 302 may be responsive to user input to display, for example registration data 126 from various web pages of the registration service on the display 118. The user actuates, for example, direction keys 311, 312, 314, 316 on the input device 120 of telecommunication device 104 through a particular graphical user interface (GUI) being displayed on telecommunication device 104. The user actuates the OK key 318, or right and left selection keys 320, 322 of the keypad on the telecommunication device 304 to select a particular transaction or option from the GUI. For example, the user may use direction keys 311, 312, 314, 316 and OK key 318 to select, for example, the hyperlink included in registration notification 230 in order to generate the registration request 308 and retrieve registration data 126 from the registration database 206.

Referring back to FIG. 2A, an authentication component 233 of the server application 202 authenticates the registration request 122 received from the telecommunication device 104 via the mobile registration application 117 to verify that the user of the telecommunication device 104 is authorized to participate in mobile registration. The authentication component 233 authenticates the registration request 208 by comparing user authentication data received from the telecommunication device 104 along with the registration request 122 to authorization data stored in a database 234 on the central server 202. For example, the database 234 may be a authentication database that contains information necessary to validate a request from a client (as well as other users on the network) to retrieve registration data 126 from the registration database 206. Although authentication database 234 is illustrated as being separate from the registration database 206, it is understood that in other aspects of the mobile registration system 10 the authentication database 234 and registration database can be a single database. Alternatively, the authentication database 234 may be located on a separate authentication server (i.e., not contained within server 204). Stored authentication data may include a password previously defined by the user of the telecommunication device 104 or a device ID previously provided from the telecommunication device 104. If user authentication data received from the telecommunication device 104 does not match authentication data stored in the authentication database 234, the user is not authenticated and denied access to registration data 126. On the other hand, if the user authentication data received from the telecommunication device 104 matches the authentication data stored in the database 234, the user is authenticated and allowed to retrieve and manipulate registration data 126 from the registration database 206.

In one embodiment, the mobile registration application 117 receives an action request 309 from an authenticated telecommunication device 104 and forwards the action request to the server application 202. The action request 309 requests the retrieval of specific registration data 126 from the registration database 206 such as a course schedule, course registration number, course details, etc, and is generated by the telecommunication device 104 in response to the user input entered via an event driven graphical user interface 310.

A retrieval component 236 is responsive to an action request 309 from an authenticated telecommunication device 104 to retrieve the requested registration data 126 and transfers the retrieved registration data 126 to the telecommunication device 104 via the mobile registration application 117.

A conversion component 240 of the mobile registration application 117 converts registration data to a format that can be communicated to the telecommunications device 104 via the wireless network. For example, the registration data may be converted from a format that is communicated over a communication network using a hypertext transfer protocol (http) to a format that can be transmitted over a communication network using a wireless application protocol (WAP). In other words, the conversion component 240 converts registration data 126 to a format that can be transmitted to and fully viewed on the display 118 of the telecommunication device 104. Moreover, the conversion component 240 identifies the minimum amount of registration data 126 and/or tasks necessary to complete a particular transaction on the telecommunication device 104.

Referring to FIG. 2C, the conversion component 240 may execute one or more modules or instructions to convert registration data 126 from an http format to a format that can be communicated to the telecommunications device 104 for display. A task optimization engine (TOE) module 250 receives the action request 309 from the telecommunication device 104. In this example, the action request 309 requests data from a standard web or server application 252 that is not configured to provide data in a format adapted for viewing on a telecommunication device 104. The TOE module 250 processes the action request 309 and identifies the requested web application 252. The TOE module 250 then compares the identified web application 252 with supported web applications identified in a predefined list of TOE templates retrieved from a TOE template table 254. Each of the predefined TOE templates corresponds to a web application that can be converted by the conversion component 240. In particular, the predefined TOE templates identify web applications or server applications that include data that can be converted to a format that can be viewed on the telecommunication device 104. According to one embodiment, each predefined TOE template has a 1:1 ratio with a supported application. In other words, there is only one predefined TOE template per supported web application. If a matching predefined TOE template is identified, the TOE module 250 generates an http request 256 and sends the http request 256 to the requested web application 252.

The http/WAP interpreter module 258 intercepts an http response 260 from the web application 252. The http/WAP interpreter module 258 processes the http response 260 and identifies the particular data such as a particular web page returned from the web application 252. The http/WAP interpreter module 258 then compares the identified data with a predefined list of interpreter templates retrieved from an interpreter template table 262 to identify a matching interpreter template. For example, the http/WAP interpreter module 258 compares the identified data with a predefined list of interpreter templates to identify an interpreter template that corresponds to a matching web page. Notably, although the TOE template table 254 and the interpreter table 262 are shown separately, it is contemplated that they can be located in the same memory (e.g., memory 232).

Each interpreter template in the interpreter template table 262 identifies the minimum data required for viewing a particular page and/or completing a particular form of the web application on the telecommunication device. For example, each interpreter template includes business rules that define how data from a particular page of the web application will be displayed on the telecommunication device 104. For example, an interpreter template may identify data such as text, input fields, links, and images from a particular page of the web application 252 that should be displayed on the display of the telecommunication device 104. The interpreter template may also specify where such data should be displayed on the display 118 of the telecommunication device 104. Interpreter templates can also include instructions for dividing a single web page into multiple pages. For example, if the minimum amount data of a particular page that is required to complete a task cannot be efficiently displayed on the display of the telecommunication device, the template may divide the particular page into two or more pages. The interpreter template may further include instructions for inserting links at the end of the created pages so that successive pages can be linked. The types of business rules described above are not exhaustive, and it is contemplated that interpreter templates may include other rules for efficiently converting data to a format adapted for viewing on a telecommunication device 104.

Each interpreter template has a 1:N ratio with a supported web application. In other words, there may be multiple interpreter templates for each supported web application. These multiple interpreter templates correspond, for example, to the multiple web pages within a particular supported web application. If a matching interpreter template is identified, the http/WAP interpreter module 256 converts the data (e.g., registration data) included in the http response 260, to a WAP format, and generates a WAP response 264 comprising the data in the WAP format for transmission to the telecommunication device 104. The WAP response 264 includes registration data that can be fully viewed on the display 118 of the telecommunication device 104.

According to another aspect, TOE module 250 includes a TOE session cache 266 that stores information regarding the life of a mobile session including information used to complete tasks identified in the TOE template.

According to another aspect, the TOE module 250 is configured to optimize the user experience by automatically generating a http request 258 to retrieve information that may be desired by the user based on the TOE session cache 266 and information included in the TOE templates contained in the TOE template table 254. In this case, rather than the http/WAP interpreter module 256 converting the data (e.g., registration data) included in the http response 260 into a telecommunication device 104 format, the http/WAP interpreter module 256 forwards the data included in http response 260 to the TOE module 250 for caching. As a result, if the user desires this information to complete a task during a communication session, the information is readily available via the TOE session cache 266.

Referring back to FIG. 2A, a transfer component 242 transfers the WAP response 264 including the converted registration data 126 to the telecommunication device 104. For example, the transfer component 242 may transfer registration menu data in the form of a graphical user interface 310 to the telecommunication device 104 configured for viewing on the display 118. However, rather than displaying the same registration menu data that would be displayed to students participating in a mobile registration process via a non-telecommunication device (e.g., personal computer or laptop), the minimum amount of registration data 126 and/or tasks necessary to complete a particular transaction is displayed on the telecommunication device 104. Thereafter, the transfer component 242 is responsive to user input selecting specific menu data via the menu graphical user interface to transfer various other graphical user interfaces to the particular telecommunication device 104 for viewing on the display 118. Again, rather than displaying the same information that would be viewed by students on corresponding graphical user interfaces for non-telecommunication devices, the conversion component 240 intelligently identifies the minimum amount of registration data 126 necessary to complete a particular transaction for each of the various other graphical user interfaces 310 being viewed on the display 118.

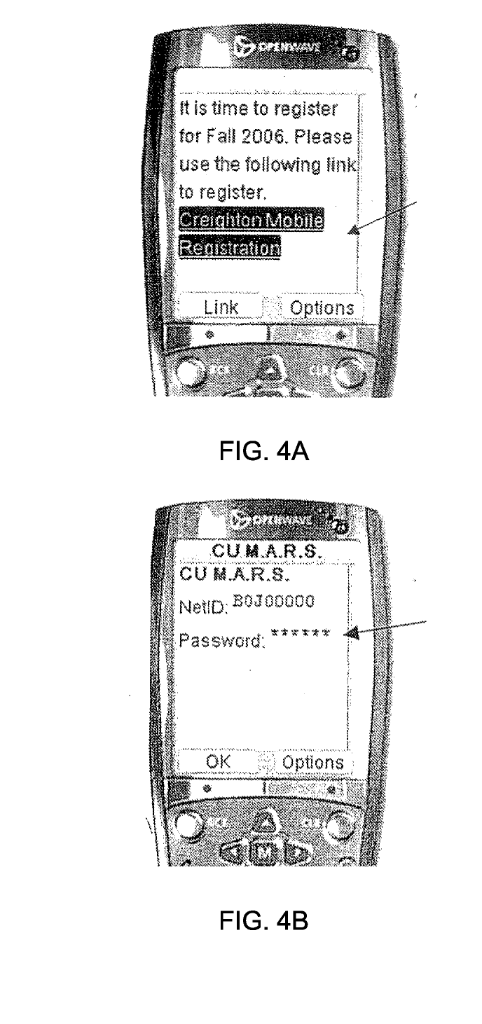

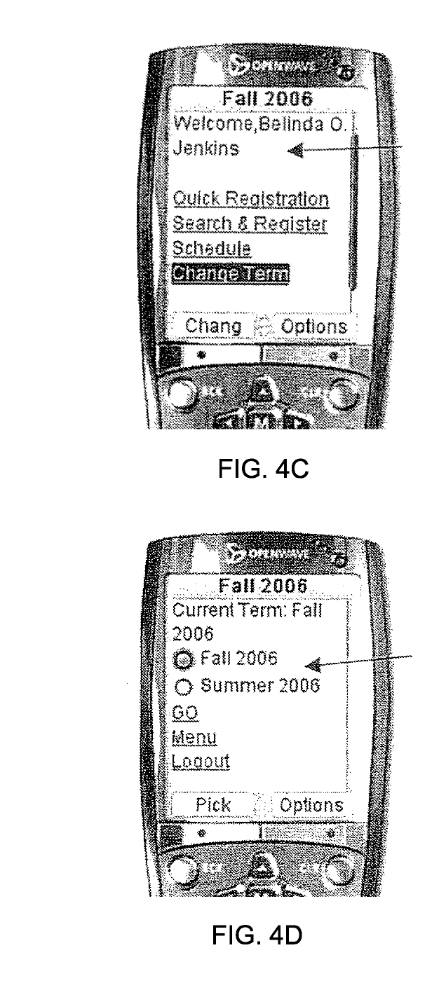

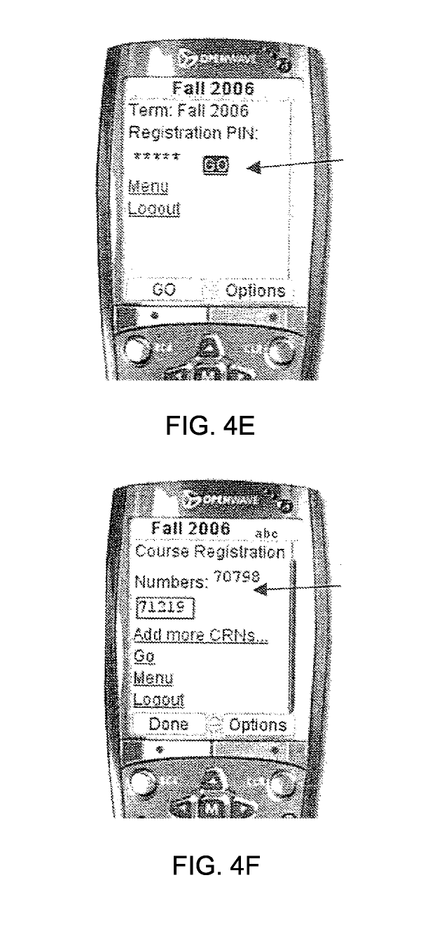

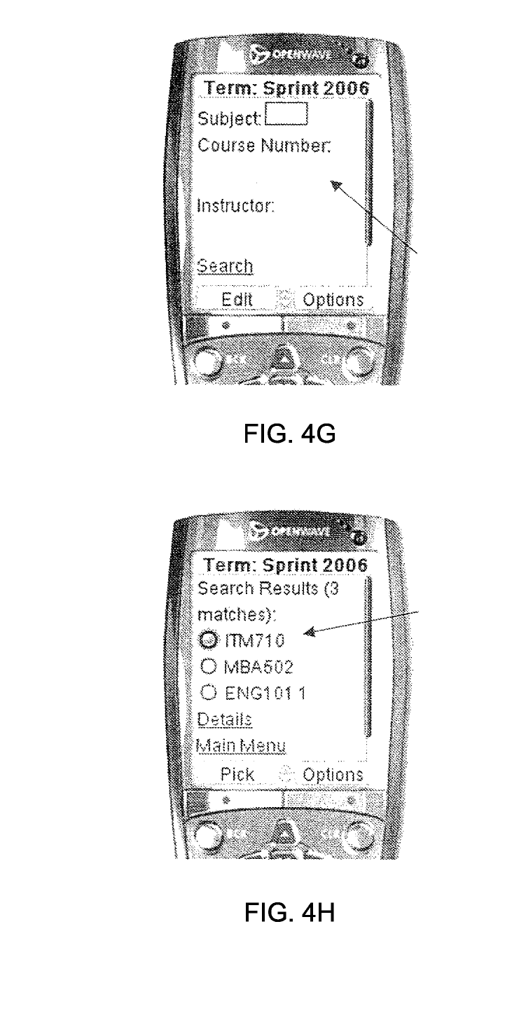

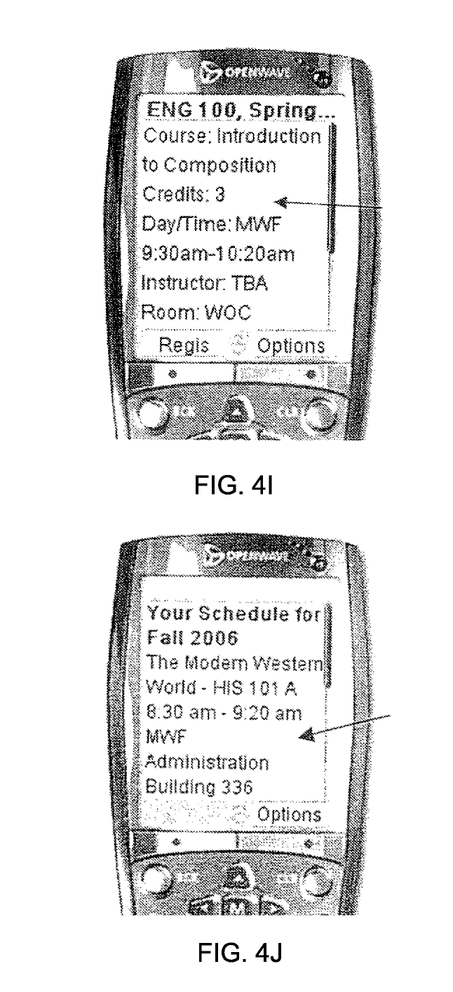

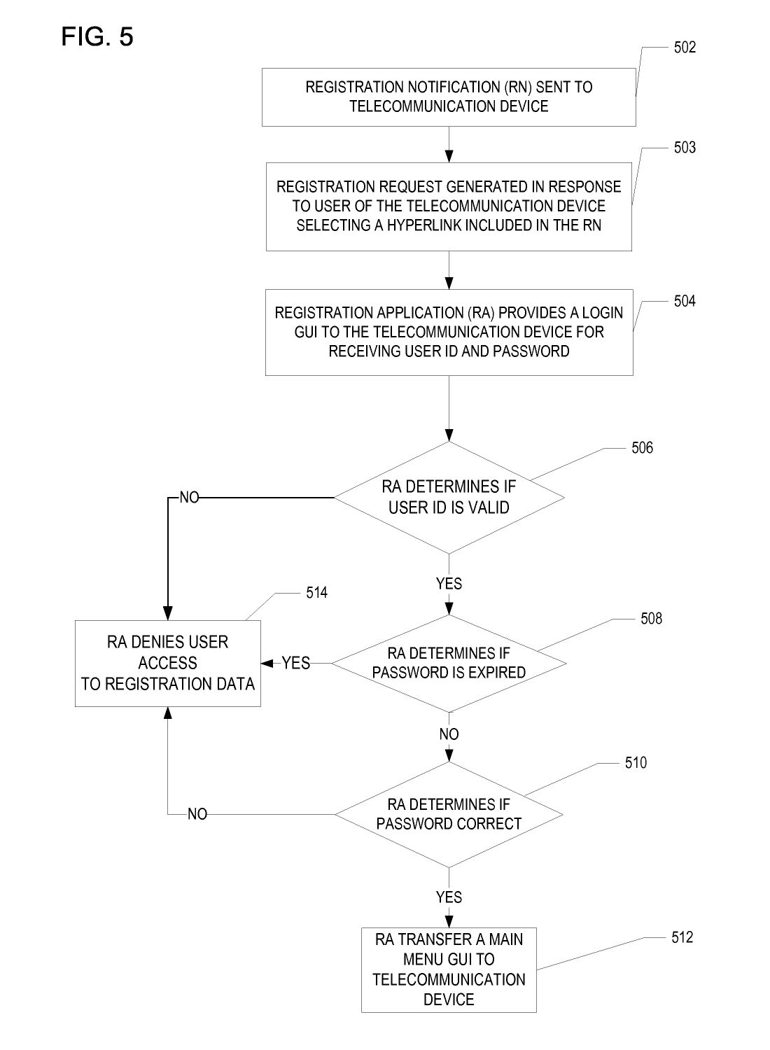

In operation, the server application 202 sends registration notification 230 to students eligible to participate in mobile registration system 10 at the occurrence of an event (e.g., registration period opens, or server administrator initiates the event). Textual data and contextual data (e.g., hyperlink) included in the registration notification 230 is shown on display 118 of the telecommunication device 104. For example, a screen shot (FIG. 4A) may show the contents of a registration notification 230 that includes test and a hyperlink, for example, “Creighton Mobile Registration.” The user of the telecommunication device 104 may use the user interface 120 to select the transmitted hyperlink. After the user selects the hyperlink, telecommunication device 104 sends a registration request 308 to the server 204. The server application 202 is responsive to the received registration request 308 to transfer a login GUI to the telecommunication device 104. The mobile registration application 117 converts the login GUI to a format adaptive for viewing on the telecommunication device 104 (FIG. 4B). As discussed below in reference to FIG. 5, after the user of the telecommunication device 104 enters valid user authentication data, the server application 202 transfers a main menu GUI, to the telecommunication device 104 via the mobile registration application 117. The mobile registration application 117 converts the main menu GUI to a format adaptive for full viewing on the display 118 of the telecommunication device 104 and determines what information is necessary to make such a display on the main menu GUI. (FIG. 4C)

By default, the server application 202 may define the term for which the student desires to register as the current term (e.g., term defined as fall semester if registration occurring during September). The user can change the default term by using the keypad to highlight and select the “change” menu option. The server application 202 may be responsive to the user selecting the “change” option to transfer a term selection GUI to the telecommunication device 104. The mobile registration application 117 converts the term selection GUI to a format adaptive for full viewing on the telecommunication device 104. (FIG. 4D).

The authenticated user may then select the “quick registration” option from the main menu GUI if the user knows a course registration number (CRN) that corresponds to a course for which the student desires to register. The server application 202 is responsive to the user by transferring a personal identification number (PIN) entry GUI to the mobile telecommunication device 104. The mobile registration application 117 converts the PIN Entry GUI to a format adaptive for viewing on the telecommunication device 104. (FIG. 4E). The PIN identification number could be provided to the user by the educational institution prior to registration and is used, for example, to identify the student, insure that the student is in good standing, and/or only allow the student to register for courses for which he or she may be eligible (i.e., courses in their elected area of study or class status) and/or indicate registration timeframe. The PIN identification number can be provided via email, regular mail or and other delivery medium. The user enters the PIN identification number into the Pin entry GUI using the input device 120 of the telecommunication device 104 and selects a “GO” option to continue with quick registration. The server application 202 is responsive to the user entering a valid PIN identification number to transfer a CRN entry GUI to the telecommunication device 104. The mobile registration application 117 converts the CRN entry GUI to a format adaptive for full viewing on the telecommunication device 104. (FIG. 4F). After the user has successfully registered for a course, the server application 202 sends a registration confirmation electronically to the user via the mobile registration application 117. Thereafter, the user can receive the confirmation via the telecommunication device 104.

Alternatively, the authenticated user can select the “search & register” option from the main menu GUI if the user does not know a CRN that corresponds to a course for which the student desires to register. The server application 202 is responsive to the user selecting the “search & register” option to transfer the search GUI to the telecommunication device 104. The mobile registration application 117 converts the Search entry GUI to a format adaptive for full viewing on the telecommunication device 104 (FIG. 4G). The user enters at least one character into the search field and uses the input device 120 of the telecommunication device 104 to select a “Search” option displayed on the search GUI to initiate a search of the registration database 206 and identify registration data 126 for courses that have matching characters. For example, the server application 202 may identify one or more CRNS that include characters that match the one or more characters entered by the user. The server application 202 transfers a search results GUI to the telecommunication device that list identified matching courses. The mobile registration application 117 converts the search results GUI to a format adaptive for full viewing on the telecommunication device 104 (FIG. 4H). Optionally, the user can view details of a particular course included in the list of identified matching courses by using the keypad 120 of the telecommunication device 104 to select an option button adjacent to that particular CRN and then using the keypad to select a “Details” option. The server application 202 is responsive to the user selecting the “Details” option to transfer a Details GUI to the telecommunication device 104. The mobile registration application 117 converts the Details GUI to a format adaptive for full viewing on the telecommunication device 104 (FIG. 4I).

Alternatively, the authenticated user can select the “Schedule” option from the main menu GUI. The server application 202 is responsive to the user selecting the “Schedule” option to transfer a Schedule GUI to the telecommunication device 104 to display a list of courses for which the user has registered in a schedule format. The mobile registration application 117 converts the Schedule GUI to a format adaptive for full viewing on the telecommunication device 104 (FIG. 4J).

FIG. 5 illustrates a method for accessing a mobile registration system 10 of an educational institution via telecommunication device 104. A registration notification 116 is sent from central server 102 for executing the registration application 108 to the telecommunication device 104 at step 502. As described above, a user of the telecommunication device 104 views the registration notification 116 on the display 118. The user then operates the input device 120 of the telecommunication device 104 to select a hyperlink included in the registration notification 116 to generate a registration request 122 at step 503. At step 504, the registration application 108 provides a login form/GUI to the telecommunication device 104 via the mobile registration application 117 that is used by the user to enter a user identification code (i.e., user ID) and/or password in order to log into the mobile registration system 10. At step 506, the registration application 108 receives the user ID via the via the mobile registration application 117 and determines if the user ID received with the registration request 122 is valid. For example, the registration application 108 may compare the user ID received along with the registration request 122 to valid user ID data stored in a authentication database on the central server 102 to determine if the user ID is valid. If the user ID is determined to be valid at decision point 506 (e.g., received user ID data matches the stored user ID data), the registration application 108 determines if the received password has expired at step 508. For example, on the date the user is first assigned or defines a password, an expiration date parameter is defined based on a predetermined period of validity (e.g., 90) days. In other words, the password will expire after the predetermined period of validity expires, which may begin from the date the password was first assigned or defined and is stored in the registration database 110. The registration application 108 then compares the current date (i.e., the date the user is attempting to login to mobile registration service) with the stored expiration date to determine if the received password has expired. If the password is determined not to have expired at step 508 (e.g., received user ID data matches the stored user ID data), the registration application 108 determines if the received password is correct at step 510. For example, the registration application 108 may compare the password received along with the registration request 122 to valid password data stored in a database on the central server 102 to determine if the user ID is valid. If the password is determined to be correct at step 510 (e.g., received password matches the stored password data), the server application transfers a main menu GUI via the mobile registration application 117 for display on the telecommunication device 104 at step 512. If the user ID is determined to be invalid at step 506 (e.g., received user ID data does not match stored user ID data), the password is determined to be expired at step 508 (e.g., current date is beyond stored expiration date), or the password is determined to be incorrect at step 512 (e.g., received password does not matches the stored password data), the user of the telecommunication device 104 is denied access to the mobile registration service and prompted to re-enter user ID and password at step 514.

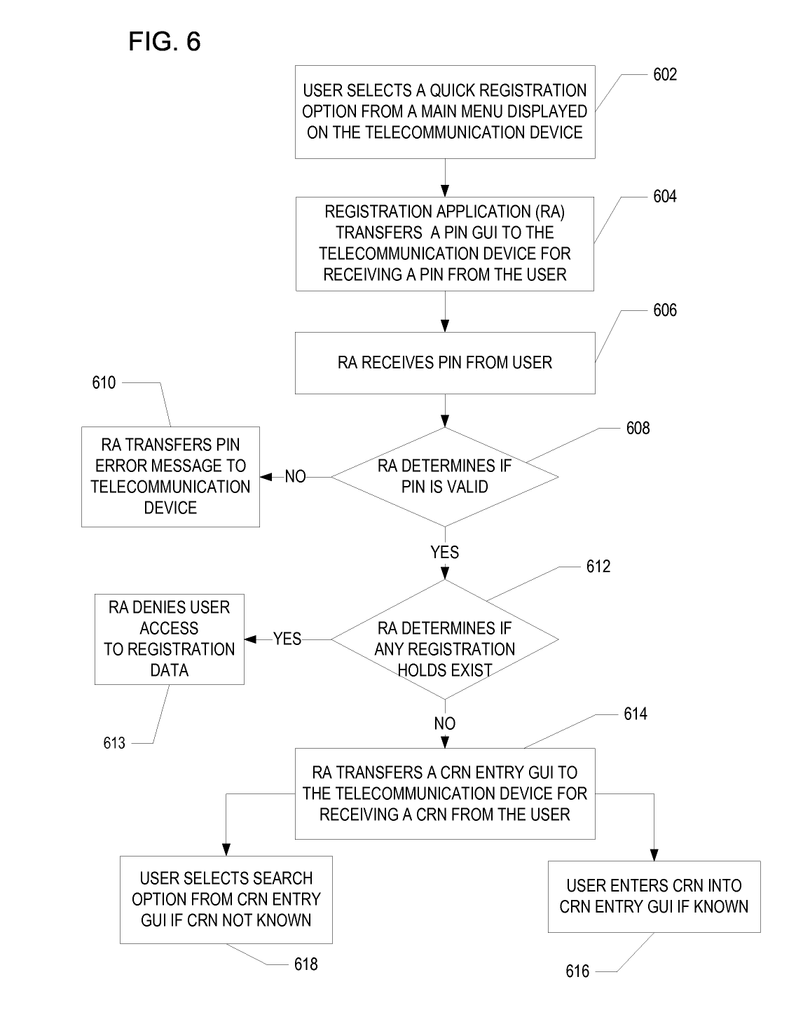

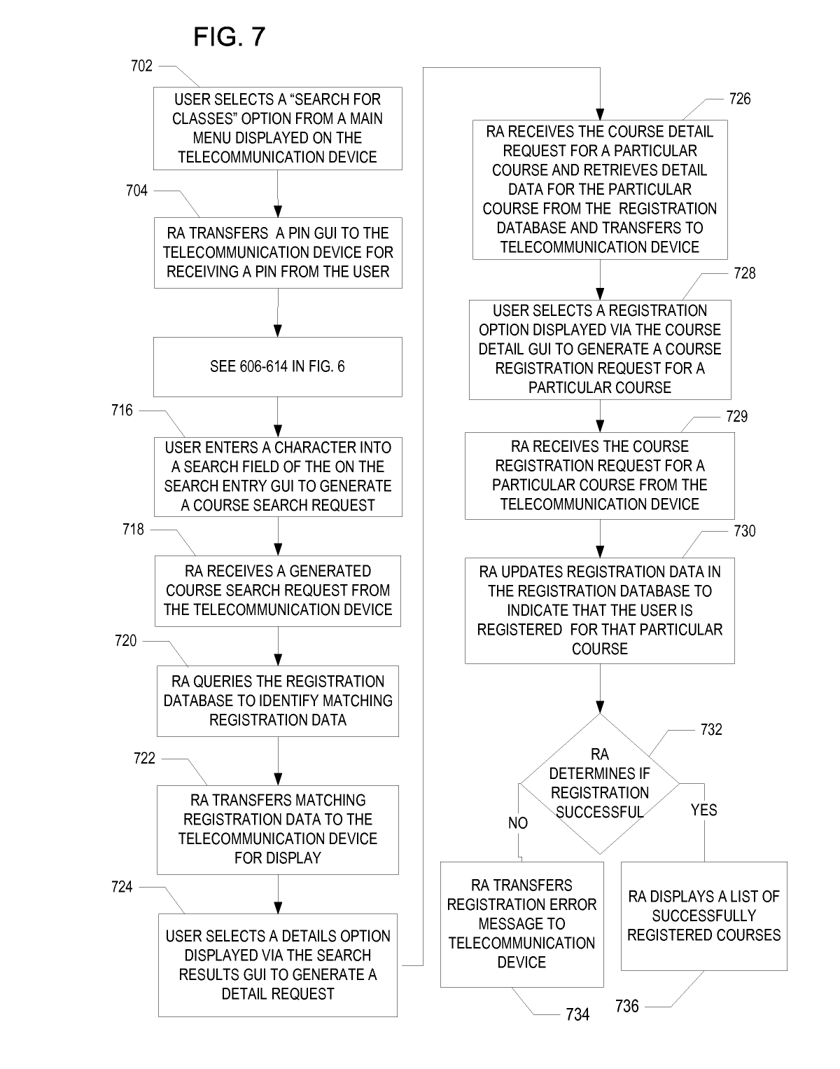

FIG. 6 illustrates a method for registering for courses using mobile registration system 10 of an educational institution via a telecommunication device 104. Subsequent to the user of a telecommunication device 104 successfully logging into the mobile registration system 10 to view the main menu page on the telecommunication device 104, the user operates the input device 120 of the telecommunication device 104 to make a selection from the menu being shown on the display 118 of the telecommunication device 104. In this example, the user may select a “quick registration” option from the main menu at step 602. The registration application is responsive to the user selecting the quick registration option to transfer a personal identification number (PIN) entry GUI to the telecommunication device 104 that is converted by the mobile registration application 117 to a format adaptive for full viewing on the telecommunication device 104 at step 604. The user enters a PIN previously provided to the user from the educational institution into the PIN entry GUI at step 606. At decision point 608, the registration application 108 receives the entered PIN via the mobile registration application 117 and determines if the received PIN is valid. For example, the (registration application) 108 compares the received PIN to valid PIN data stored in a database on the central server 102 to determine if the PIN is valid. If the PIN is determined invalid at decision point 608 (e.g., received PIN does not match the stored PIN data), the registration application 108 transfers a PIN error message to telecommunication device 104 via the mobile registration application 117 that is displayed on the UI of the telecommunication device at step 610. If the PIN is determined valid at decision point 608 (e.g., received PIN matches the stored PIN data), the registration application 108 determines if any registration holds exist for the particular student associated with the PIN at step 612. A registration hold can be due to, for example, the academic status of the student or outstanding financial obligations.

If a registration hold is determined to exist at decision point 612, the registration application 108 denies the user access to registration data at step 613. If no registration hold is determined to exist at decision point 612, the registration application 108 transfers a CRN entry GUI that is converted by the mobile registration application 117 to a format adaptive for full viewing on the telecommunication device 104 at step 614. If the student knows the course registration number (CRN) that corresponds to a course for which the student desires to register, the student enters the CRN into a CRN field on the CRN entry GUI at step 616. The course CRN entry GUI includes an “add more CRNs option,” which can be selected by the user to enter additional CRNs corresponding to courses for which the student desires to register. If the student does not know the course CRN that corresponds to a course for which the student desires to register, the student selects a search option displayed on the CRN entry GUI at step 616.

Referring to FIG. 7, method for registering for courses using the mobile registration system of an educational institution via a telecommunication device is illustrated. Subsequent to the user of a telecommunication device 104 successfully logging into the mobile registration system 10 to view the main menu page on the telecommunication device 104, the user operates the input device 120 on the telecommunication device 104 to make a selection from the menu being shown on the display 118 of the telecommunication device 104. In this example, user may select a “Search for Classes” option from the main menu at step 702. The registration application 108 is responsive to the user selecting the “Search for Classes” option by transferring a personal identification number (PIN) entry GUI that is converted by the mobile registration application 117 to a format adaptive for viewing on the telecommunication device 104 at step 704. The PIN entry process is substantially the same as the PIN entry process at steps 606-614 described above in reference to FIG. 6. However, in this instance, because the student does not know the course registration number (CRN) that corresponds to the course for which the student desires to register, the student may then enter the minimum amount of criteria into the search field on the course search form at step 716. For example, after entering the minimum criteria into the course search field, the user operates the input device such as an input device 120 such as a keypad of the telecommunication device 104 to select a “Search” option from the CRN entry GUI to generate a course search request (i.e., type of action request 309) at step 718. The registration application 108 receives the course search request via the mobile registration application 117 and is responsive to generated course search request to search a database (e.g., registration database) linked to the central server 102 to identify matching courses at step 720. For example, the registration application 108 may identify one or more courses that match the criteria provided by the user at step 716. The mobile registration application 117 then transfers identified courses to the telecommunication device 104 for display on the UI of the telecommunication device 104 at step 722.

Optionally, the user can view details of a particular course by operating the selection keys of the mobile telecommunication device 104 to select an option button adjacent to that particular course and then selecting the “Details” option to generate a course detail request at step 724. The registration application 108 is responsive to the generated course detail request to search the registration database 206 to retrieve details for the selected course and to transfer the retrieved details to the mobile telecommunication device 104 via mobile registration application 117 for presentation on the display 118 of the mobile telecommunication device 104 at step 726. After viewing the details of the particular course, the user can register for that particular course by selecting a “registration” option to generate course registration request (e.g., type of action request 309) at step 728. At step 729, the registration application 108 receives the course registration request from the telecommunication device 104 via the mobile registration application 117. The registration application 108 is responsive to the generated action request to update registration data 126 in the registration database 206 to indicate that the user is registered for that particular course at step 730. The registration application 108 determines if registration was successful at decision point 732. For example, the registration application 108 may determine if there is a registration error due to a closed section, duplicate registration, class restriction, time conflict, etc. If the registration application 108 determines that registration is unsuccessful at step 732, a registration error message is generated and transferred to the telecommunication device via the mobile registration application 117 for display 118 on the telecommunication device 104 at step 734. Alternatively, if the registration application 108 determines that registration is successful at decision point 732 (e.g., no errors are detected), a list of successfully registered courses is displayed in a schedule format at step 736.

In operation, a computer readable medium 130 executes computer-executable instructions such as those illustrated in the FIGS. 5-7 to implement embodiments of the invention.

The order of execution or performance of the operations in embodiments of the mobile registration system 10 illustrated and described herein is not essential, unless otherwise specified. That is, the operations may be performed in any order, unless otherwise specified, and embodiments of the mobile registration system 10 may include additional or fewer operations than those disclosed herein. For example, it is contemplated that executing or performing a particular operation before, contemporaneously with, or after another operation is within the scope of embodiments of the mobile registration system 10.

Embodiments of the mobile registration system 10 may be implemented with computer-executable instructions. The computer-executable instructions may be organized into one or more computer-executable components or modules. Aspects of the invention may be implemented with any number and organization of such components or modules. For example, aspects of the mobile registration system 10 are not limited to the specific computer-executable instructions or the specific components or modules illustrated in the figures and described herein. Other embodiments of the mobile registration system 10 may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A method for registering for a service via a telecommunication device, the method comprising:
storing registration data in a registration database at a server, the registration data comprising user registration data and service registration data;
identifying an eligible user from the user registration data;
transmitting a registration notification from the server to the telecommunication device of the eligible user, the registration notification notifying the eligible user that registration for the service is available;
receiving a registration request at the server from the eligible user via the telecommunication device, the registration request requesting service registration data from the server;
converting the service registration data from a first format to a second format, the first format configured for viewing on a non-telecommunication device and the second format configured for viewing on the telecommunication device;
displaying the service registration data in the second format on a display of the telecommunication device;
receiving input data at the server from the user via the telecommunication device, the input data defining a registration preference for the service; and
registering the user for the service based on the input data.

2. The method of claim 1 wherein the registration request includes user authentication data, and the method further comprising:
storing authentication data in an authentication database; and
authenticating the registration request by comparing user authentication data to the authentication data stored in the authentication database to determine if the user is authorized to register for the service.

3. The method of claim 2 wherein the authentication data includes a password previously defined by a user of the telecommunication device.

4. The method of claim 2 wherein the authentication data includes a device identification (ID) previously obtained from the telecommunication device.

5. The method of claim 1 wherein the registration data in the first format is adapted for transmission over a communication network in a hypertext transfer protocol (http), and wherein the registration data the second format is adapted for transmission over a communication network in a wireless application protocol (WAP).

6. The method of claim 1 wherein the registration notification is a text message or an email message.

7. The method of claim 1 wherein the service registration data in the second format includes registration menu data, and the method further comprising displaying the registration menu data via a graphical user interface on the display of the telecommunications device.

8. The method of claim 7 wherein the graphical user interface displays one or more registration options, and wherein the input data is generated based on the user selecting at least one of the one or more registration options.

9. One or more computer-readable media having computer-executable components for allowing a user to interact with registration data for a service via a telecommunication device, the computer-readable medium comprising:
a registration database to store registration data, the registration data comprising user registration data and service registration data;
a notification component responsive to the user registration data to transmit a registration notification to the telecommunication device of at least one user, the registration notification notifying the at least one user that registration for the service is available;
an authentication component to authenticate a registration request received from the user via the telecommunication device by authenticating that the user has registration authority for the service;
a retrieval component is responsive to an authenticated registration request to accept an action request received from the telecommunication device and to retrieve specific registration data identified by the action request;
a conversion component to convert the specific registration data from a first format to a second format that can be viewed on the telecommunication device; and
a transfer component to transfer the converted registration data in the second format to the telecommunication device for display to the user.

10. The computer readable medium of claim 9 wherein the specific registration data identified by the action request includes course schedules, course registration numbers, and course details.

11. The computer readable medium of claim 9 wherein the registration data in the first format is adapted for transmission over a communication network in a hypertext transfer protocol (http), and wherein the registration data the second format is adapted for transmission over a communication network in a wireless application protocol (WAP).

12. The computer readable medium of claim 9 wherein the registration notification is a text message or an email message.

13. The computer readable medium of claim 9 wherein the registration request includes user authentication data, and wherein the authentication component further:
stores authentication data in an authentication database; and
authenticates the registration request by comparing user authentication data to the authentication data stored in the authentication database to determine if the user is authorized to register for the service.

14. The computer readable medium of claim 13 wherein the authentication data includes a password previously defined by a user of the telecommunication device.

15. The computer readable medium of claim 9 wherein the service registration data in the second format includes registration menu data, and the transfer component further displays the registration menu data via a graphical user interface on the display of the telecommunications device.

16. The computer readable medium of claim 15 wherein the graphical user interface displays one or more registration options, and wherein input data is generated based on the user selecting at least one of the one or more registration option, and wherein the input data defines a registration preference for the service.

17. A computerized system for registering a user for a service in response to a registration request received at a server computer from a telecommunication device, the registration request comprising information identifying the user, the system comprising:
a registration database to store registration data, the registration data comprising user registration data and service registration data;
a server application comprising:
an authentication component to authenticate the registration request received from the user via the telecommunication device by authenticating that the user has registration authority for the service; and
a retrieval component is responsive to an authenticated registration request to accept an action request received from the telecommunication device and to retrieve specific registration data identified by the action request; and
a mobile registration application comprising:
a conversion component to convert the specific registration data from a first format to a second format that can be viewed on the telecommunication device; and
a transfer component to transfer the converted registration data in the second format to the telecommunication device for display to the user.

18. The system of claim 17 wherein the server application further comprises an authentication database to store authentication data, wherein the registration request includes user authentication data, and wherein the authentication component authenticates the registration request by comparing user authentication data to the authorization data stored in the authentication database.

19. The system of claim 17 wherein the specific registration data identified by the action request includes course schedules, course registration numbers, and course details.

20. The system claim 17 wherein the registration data in the first format is adapted for transmission over a communication network in a hypertext transfer protocol (http), and wherein the registration data the second format is adapted for transmission over a communication network in a wireless application protocol (WAP).

21. The system of claim 17, wherein the conversion component comprises:
a task optimization engine module template table comprising a list of templates, wherein each of the list of templates identifies a supported server application;
an interpreter template table comprising another list of templates, wherein each of the other list of templates specifies business rules for converting data included in one or more web pages of the desired server application from a first format to a second format that can be viewed on the telecommunication device;
a task optimization engine module is responsive the authenticated action request to:
retrieve the list of templates from the task optimization module template table;
compare the server application to each of the supported server applications identified by the list of templates to identify a match between the server application and a supported server application; and
transmit a hypertext transfer protocol (http) request to the server application only if the server application matches a supported server application; and
an interpreter module to intercept a http response from the server application, the http response includes the registration data specified by the action request; wherein the interpreter module is responsive to the http response to:
retrieve the other list of templates from the interpreter template table;
compare the data included in the http response to identify a corresponding interpreter template; and
converting the registration data included in the http response from the first format to the second format based on the business rules included in the corresponding interpreter template.

22. A computerized system for displaying data from a server application on a telecommunication device, the system comprising:
a task optimization engine module template table comprising a list of templates, wherein each of the list of templates identifies a supported server application;
an interpreter template table comprising another list of templates, wherein each of the other list of templates specifies business rules for converting data included in one or more web pages of the desired server application from a first format to a second format that can be viewed on the telecommunication device;
a task optimization engine module for receiving an action request from a telecommunication device, the action request specifying a desired server application and specifying data to retrieve from the desired server application; wherein the task optimization engine module is responsive to the action request to:
retrieve the list of templates from the task optimization module template table;
compare the desired server application to each the supported server applications identified by the list of templates to identify a match between the desired server application and a supported server application; and
transmit a hyper text transfer protocol (http) request to the desired server application only if the desired server application matches a supported server application; and
an interpreter module to intercept a http response from the desired application, the http response comprising the data specified by the action request, wherein the interpreter module is responsive to the http response to:
retrieve the other list of templates from the interpreter template table;
compare the data included in the http response to each of the other list of templates to identify a corresponding interpreter template;
convert the data included in the http response from the first format to the second format based on the business rules included in the corresponding interpreter template; and
generate a wireless application protocol (WAP) response comprising data in the second format; and
a transfer component to transmit the WAP response to the telecommunication device, wherein the telecommunication device is responsive to the WAP response to display the data in the second format.
